(19) United States
(12) Patent Application Publication
(10) Pub. No.: US 2008/0244890 A1
(43) Pub. Date: Oct. 9, 2008

(54) Method For Producing a Strand Guiding Roller, a Strand Guiding Roller Produced By the Method and the Use Therereof

(76) Inventor: Karl Moerwald, St. Florian (AT)

Correspondence Address: OSTROLENK FABER GERB & SOFFEN, 1180 AVENUE OF THE AMERICAS, NEW YORK, NY, 100368403, US

(21) Appl. No.: 12/090,723

(22) PCT Filed: Oct. 2, 2006
(86) PCT No.: PCT/EP2006/009542

§ 371 Date: Apr. 18, 2008

(30) Foreign Application Priority Data
Oct. 20, 2005 (AT) A1718/05

(51) Int. Cl. B23P 11/00; B23K 31/02; B23P 13/04

(52) U.S. Cl. 29/428; 228/160; 29/558

(57) ABSTRACT

A method for producing strand guiding rollers from prefabricated and semifinished, stored components, which comprise at least roller bearings, prefabricated supporting shafts and semifinished roller shell starting material. The method is intended to produce and deliver a ready-to-assemble strand guiding roller in a short time with minimized stockkeeping costs. Roller bearings are in stock in a type series in accordance with the loads that occur, supporting shafts carrying the roller bearings are in stock in a type series in accordance with the loads that occur, and roller shells are in stock in the form of circumferentially worked bar or tube material in a type series with indeterminate length made to match various roller diameters. For assembly of a specific strand guiding roller, a roller shell with a roller diameter in accordance with the type series is cut off from the circumferentially worked bar or tube material in accordance with the type series to correspond to the intended body length, and is finished and assembled with the other components selected from the type series to form a strand guiding roller.

The invention relates to a method for producing a strand guiding roller for a continuous casting plant from prefabricated and semifinished components that are kept in stock. Furthermore, the invention relates to a strand guiding roller produced by the production method and to the use thereof.

Strand guiding rollers are used in a continuous casting plant for guiding and supporting an at least partially solidified metal strand emerging from a continuous casting mold and are known as such in many different types of construction. Depending on the width of the cast metal strand, strand guiding rollers are mounted at two or more locations and accordingly have different body lengths. Specifically when casting metal strands of great width and thickness, strand guiding rollers that are mounted at more than two locations are used, rollers that follow successively in the casting direction having bearing locations that are offset in relation to one another in order to ensure good two-dimensional support of the strand.

This inevitably leads to different body lengths. The structure of known strand guiding rollers is also varied and is determined very much by the coolant circulation inside the roller body. Right after the metal strand emerges from the mold, it is necessary for the strand guide to be provided with strand guiding rollers as close together as possible (low roller spacing), to avoid bulging. With increasing distance from the mold, the roller spacing can become greater. This produces a roller corset in the strand guide, with strand guiding rollers of different diameters.

Under the effect of the hot and heavy metal strand, strand guiding rollers are exposed to high thermal and mechanical loads, which require continual maintenance, and consequently replacement work, on the continuous casting plant.

Under these influences, the plant operator needs an adequate stock of replacement rollers, with however undesired stockkeeping costs. Plant operators therefore try to offload this problem onto the roller manufacturers and, as and when required, call at short notice for a replacement part to be delivered as quickly as possible (just-in-time delivery). For the roller manufacturers, this requires that they keep in stock rollers suitable for the requirements of many plant operators, which gets out of hand as a result of the large number of types of plant and roller systems, with in some cases only small differences in dimensions, or requires corresponding concepts for rollers to be manufactured and assembled at short notice.

The complete production of strand guiding rollers usually takes place after the receipt of corresponding orders for first-time installation and replacement parts on the basis of the production drawings. The necessary, long production times require limited stock management to maintain undisturbed production on the continuous casting plant.

It is already known from DE 10 2004 002 529 B3 to construct internally cooled supporting and/or transporting rollers from standardized modules, comprising a bearing journal, shell and core. The modules are two-dimensionally sorted and grouped together in a preferred arrangement as a range of sizes based on standard length and standard diameter. The two-dimensionality of this proposed stockkeeping has the effect that it nevertheless reaches a considerable size with undesirably great stockkeeping costs. Also proposed is a stockkeeping system with restricted two-dimensionality in which modules are created with standard lengths, the length distribution of which is statistically determined and which are only cut to the required length in the case of an actual application. The restricted two-dimensionality increases the proportion of expensive roller shell material that goes to waste all the more since the number of standard length modules is reduced. Furthermore, it is not possible to supply the plant operator with strand guiding rollers that are ready assembled and can be directly fitted, since, in particular in the case of rollers mounted at more than one location, assembly of the roller bearings is only possible when the strand guiding rollers are in the disassembled state, and also expensive split bearings are used.

The object of the invention is therefore to avoid the disadvantages of the known prior art and propose a method for producing a strand guiding roller with which it is possible in a very short time for a strand guiding roller that is ready to assemble for fitting in a continuous casting plant to be produced from prefabricated and semifinished, stored components and delivered. The stock required for this that is maintained by the roller manufacturer is to be kept as small as possible.

The object on which the invention is based is achieved on the basis of a method of the type described at the beginning by the features of claim 1.

The method for producing strand guiding rollers for a continuous casting plant from prefabricated and semifinished, stored components, which preferably comprise at least roller bearings, prefabricated supporting shafts and semifinished roller shell starting material, as well as various small items and additional internal and add-on parts, leads to a strand guiding roller that can be delivered in an extremely short time if roller bearings are in stock in a type series in accordance with the loads that occur, if supporting shafts carrying the roller bearings are in stock in a type series in accordance with the loads that occur and if roller shells are in stock in the form of circumferentially worked bar or tube material in a type series with indeterminate length made to match various roller diameters, wherein, for the assembly of a specific strand guiding roller, a roller shell with a roller diameter in accordance with the type series is cut off from the circumferentially worked bar or tube material in accordance with the type series to correspond to the intended body length, finished and assembled with the other components selected from the type series to form a strand guiding roller.

By stockkeeping the roller shells in the form of bar or tube material with indeterminate length, preferably in a length of 6 m to 8 m, only the lateral surface (diameter) being pre-worked, portions can be cut to length, to correspond to the body length required for the strand guiding roller that is to be produced, and finished at the ends in a very short time. This finishing comprises turning the end faces on a lathe and producing the connecting seats for receiving a supporting shaft journal, preferably to a diameter permitting a rotationally fixed shrink-fit connection to the supporting shaft journal. In particular in the case of strand guiding rollers that are mounted at more than one location, the body lengths of the individual roller shells lie between 500 mm and 800 mm, in some cases they even reach 1000 mm and above. Consequently, with correspondingly long bar or tube material, a greater number of roller shells can be cut to length and the proportion that goes to waste can be kept very low.

According to an advantageous refinement of the method, a wear-resistant surface layer is applied to the lateral surface of the bar or tube material, preferably by build-up welding, and the bar or tube material is subsequently turned on a lathe to the roller diameter in accordance with the type series. If appropriate, a heat treatment is additionally carried out to reduce stress and to set the microstructure in the shell of bar or tube material.

The finishing of the cut-to-length roller shell possibly also comprises the production of coolant lines. The coolant line may in this case be produced as a central coolant line, for example by a central bore in the cut-to-length piece of bar material or hollowing out the cut-to-length piece of tube material on a lathe. In the case of peripheral cooling (turret cooling), the corresponding peripheral coolant channels and branch lines are drilled.

The proposed method has proven to be particularly cost-effective if the strand guiding rollers provided or arranged in a continuous casting plant are dimensioned in dependence on the loads acting on them in accordance with a predetermined type series. This is expediently planned already during the planning and construction of the continuous casting plant, but may also take place by corresponding retrofitting on an existing continuous casting plant.

The strand guiding roller produced by the proposed method forms an independent replacement part of a continuous casting plant. A strand guiding roller that becomes damaged or worn during operation of the plant can be removed from the plant after releasing the fastening means of the bearing housings on the supporting framework of the continuous casting plant and be replaced by a strand guiding roller delivered at short notice. There is no need for any pre-assembly work at the workshops of the plant operator.

Advantages and features of the present invention emerge from the following description of a non-restrictive exemplary embodiment, reference being made to the accompanying figures, in which:

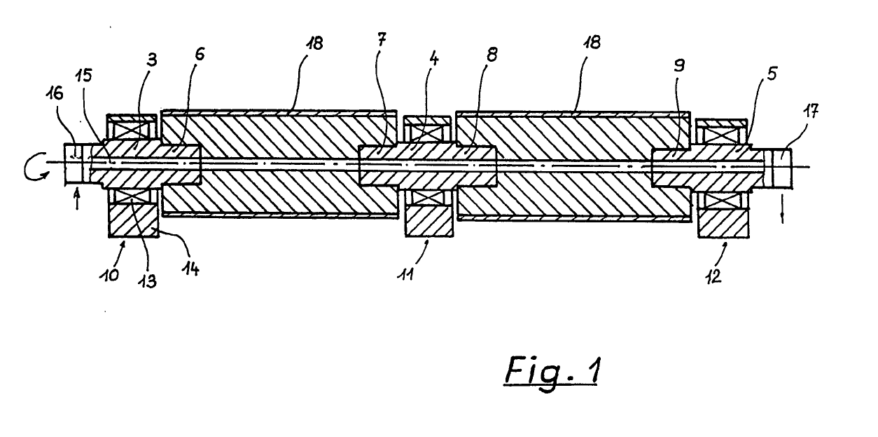

FIG. 1 shows a schematic longitudinal section through a strand guiding roller produced by the method according to the invention,

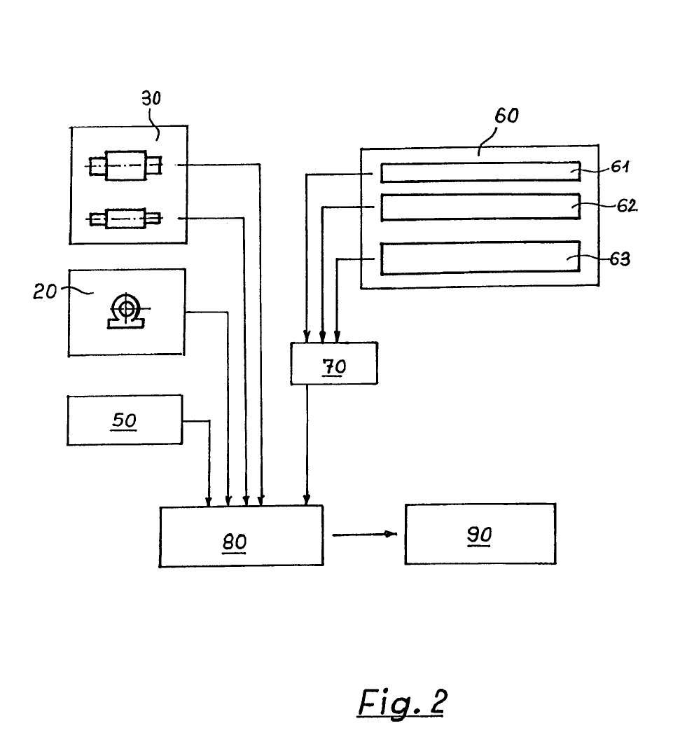

FIG. 2 shows a schematic representation of the stock management, of a part production area and of an assembly area for the production of the strand guiding roller according to the invention.

FIG. 1 shows in a schematic representation a strand guiding roller mounted at three locations, as used in the strand guidance of a continuous casting plant, and is produced and assembled by the method according to the invention from standard components, prefabricated components and semifinished components. The strand guiding roller comprises two roller shells 1, 2, which are supported on supporting shafts 3, 4, 5. The supporting shafts run out into supporting shaft journals 6, 7, 8, 9, which protrude into recesses of the roller shells and with the latter form a rotationally fixed connection, for example a shrink-fit connection. The supporting shafts 3, 4, 5 are supported in roller bearings 10, 11, 12, comprising a rolling bearing 13 and a bearing block 14. Self-aligning roller bearings and CARB bearings preferably come into consideration as rolling bearings. The strand guiding roller is passed through by a centrally penetrating coolant channel 15 and is connected at the extreme ends to rotary lead-throughs 16, 17 for leading in and leading away a coolant. The roller shells 1, 2 have a wear-resistant surface layer 18, which increases the service life of the strand guiding roller.

To minimize the production time of such a strand guiding roller, with at the same time low stockkeeping costs and storage space, individual components of the strand guiding roller are kept ready in a component store, to some extent prefabricated and to some extent semifinished. FIG. 2 illustrates the store and the production and assembly steps. Roller bearings 10, 11, 12 are stored as standard components in conformity with type series in a storage area 20, supporting shafts 3, 4 or 5 are stored as prefabricated components in conformity with type series in a storage area 30, various small items and other internal and add-on parts, such as seals, rotary lead-throughs and the like, are stored ready to assemble in a storage area 50. In the storage area 60, circumferentially worked bar or tube material 61, 62, 63, possibly circumferentially coated with a wear-resistant layer, is stored such that it is sorted on the basis of different diameters in accordance with the intended type series. In the production of a specific strand guiding roller, a piece of roller shell corresponding to the required body length of the roller shell is cut to length from the bar or tube material to correspond to the predetermined roller shell diameter in the workshop 70 and is finished. At the assembly place 80, the individual components required are brought together from the storage places 20, 30, 40, 50 and the workshop 70 and are assembled. A completely assembled strand guiding roller leaves the assembly place 80, and without any further pre-assembly work can be fitted by the plant operator in the continuous casting plant 90, aligned in its position in relation to the other strand guiding rollers and fastened.

For example, in the case of a strand guiding roller that is mounted at three locations, such as that represented in FIG. 1, the body length of the one roller shell is 520 mm and the body length of the other roller shell, in line in the axial direction, is 750 mm. In the case of the strand guiding roller following in the strand transporting direction in the strand guide of a continuous casting plant, the sequence of the roller shells with different body lengths could change and in such a way a two-dimensional support of the cast strand be achieved, since the middle bearings are not in line in the strand transporting direction. The stockkeeping of the prefabricated roller shells in the form of bars or rods that are as long as possible makes it possible to minimize the amount of stock and the residual lengths that can no longer be used.

The method according to the invention can equally be used in the case of strand guiding rollers that are mounted at two locations and strand guiding rollers that are mounted at any other number of locations.

1. A method for producing strand guiding rollers for a continuous casting plant from prefabricated and semifinished components that are kept in stock, which preferably comprise at least roller bearings, prefabricated supporting shafts and semifinished roller shell starting material, as well as various small items and additional internal and add-on parts,
wherein roller bearings are in stock in a type series in accordance with the loads occurring,
wherein supporting shafts carrying the roller bearings are in stock in a type series in accordance with the loads occurring,
wherein roller shells are in stock in the form of circumferentially worked bar or tube material in a type series with indeterminate length made to match various roller diameters,
wherein, for the assembly of a specific strand guiding roller, a roller shell with a roller diameter in accordance with the type series is cut off from the circumferentially worked bar or tube material in accordance with the type series to correspond to the intended body length, finished and assembled with the other components selected from the type series to form a strand guiding roller.

2. The method as claimed in claim 1, characterized in that a wear-resistant surface layer is applied to the lateral surface of the bar or tube material, preferably by build-up welding, and the bar or tube material is subsequently turned on a lathe to the roller diameter in accordance with the type series.

3. The method as claimed in claim 1 or 2, characterized in that the finishing of the roller shell comprises turning the end faces on a lathe and producing the connecting seats for receiving supporting shaft journals.

4. The method as claimed in claim 3, characterized in that the finishing of the roller shell additionally comprises the production of coolant lines, preferably a central coolant line.

5. The method as claimed in one of the preceding claims, characterized in that the strand guiding rollers provided or arranged in a continuous casting plant are dimensioned in dependence on the loads acting on them in accordance with a predetermined type series.

6. A strand guiding roller produced as claimed in one of claims 1 to 5.

7. A continuous casting plant with strand guiding rollers produced as claimed in one of claims 1 to 5.

8. The use of a strand guiding roller produced as claimed in one of claims 1 to 5 as a replacement part of a continuous casting plant.
